(19) United States
(12) Patent Application Publication
(10) Pub. No.: US 2015/0362163 A1
(43) Pub. Date: Dec. 17, 2015

(54) SYSTEMS AND METHODS FOR CREATING A CONFIGURABLE LUMINAIRE FIXTURE

(71) Applicant: General Electric Company, Schenectady, NY (US)

(72) Inventors: Andras KUTI, Budapest (HU); Roland BATAI, Budapest (HU); Norbert KOVACS, Budapest (HU); Istvan LASKAI, Budapest (HU)

(21) Appl. No.: 14/304,046

(22) Filed: Jun. 13, 2014

(51) Int. Cl. F21V 21/14

(52) U.S. Cl. CPC F21V 21/14

(57) ABSTRACT

Provided is a luminaire fixture include a base, connected to a fixture support, a lighting component, at least one configurable component, in communication with at least one portion of a system external to the lighting component; and a top, positioned opposite the fixture support. Also provided is a method for creating multiple lighting fixture configurations including connecting, a lighting component, including a light emitter in connection with an optical zone, to at least one configurable component, and connecting the lighting component, to a fixture support.

### FIELD OF INVENTION

The present invention relates generally to luminaire fixtures. More specifically, the present invention relates to interchangeable luminaire fixtures that mount to light supports and bollards of varying diameters and perimeters.

### BACKGROUND OF THE INVENTION

Conventional lighting fixtures (luminaires), typically attached to a base or support, convert electricity from a power source to a visible light. Luminaires may illuminate using (1) a hardware switch including an electrical connection to a power source or (2) programming logic to facilitate electrical connection to a power source when specified conditions are met (e.g., a room is occupied or during a specific time of day).

Many luminaires include high efficiency fixtures and automated controls that make adjustments based on occupancy, e.g., sensors allow for operation whenever someone is within a scanned area, or daylight sensing, e.g., sensors allow for operation based on the amount of sunlight within a scanned area. These fixtures are widely used on both indoor and outdoor lighting of commercial, industrial, and residential spaces to provide the proper lighting for the factors such as the time of day and position of lighting, among others.

Additional components may also be included within luminaries for specific applications, including, among others, reflectors, to direct the light; apertures, to limit the quantity of light entering the luminaire; a shell or housing, to align and protect luminaire components.

Luminaires come in a wide variety of shapes and sizes to accommodate lighting applications in industries such as commercial lighting, among others. Luminaires vary in size and shape due to a wide variety of lighting applications. Specifically, luminaires are adjusted in shape and/or size to produce a nominal luminous flux, i.e., the amount of light emitted by a bulb or spotlight, for the lighting application. A reason to vary the luminous flux include applications that adjust light emission (e.g., wavelength and/or direction) to accommodate sensitivity of the human eye.

Depending on the lighting application, the base or support may differ in size and shape, causing luminaires to be useful in limited application.

### SUMMARY OF EMBODIMENTS OF THE INVENTION

Given the aforementioned deficiencies, a need exists for assemblies and methods that provide for configurable luminaires including components that provide functionality external to the luminaires. Additionally, the assemblies and methods use adaptive components that enable attachment luminaries of one perimeter to bases/supports with a different perimeter.

One advantage of the embodiments of the present invention allows the use of one luminaire for multiple lighting fixture configurations. The ability to provide multiple configurations allows the same fixture to be used lighting applications with different luminous flux requirements.

In the embodiments, an exemplary luminaire fixture includes a base, having a perimeter, connected to a fixture support, having a fixture support perimeter. Also included is a lighting component, having a first component perimeter, at least one configurable component, having a second component perimeter, in communication with at least one portion of a system external to the lighting component. Finally included is a top, having a top perimeter, where the top is positioned opposite the fixture support.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is front view of a configurable luminaire assembly in accordance with the embodiments.

FIG. 2 is an exploded view of the configurable luminaire assembly of FIG. 1.

### DETAILED DESCRIPTION OF THE PREFERRED EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either, any, several, or all of the listed items.

The use of “including,” “comprising,” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. The terms “circuit,” “circuitry,” and “controller” may include either a single component or a plurality of components, which are either active and/or passive components and may be optionally connected or otherwise coupled together to provide the described function.

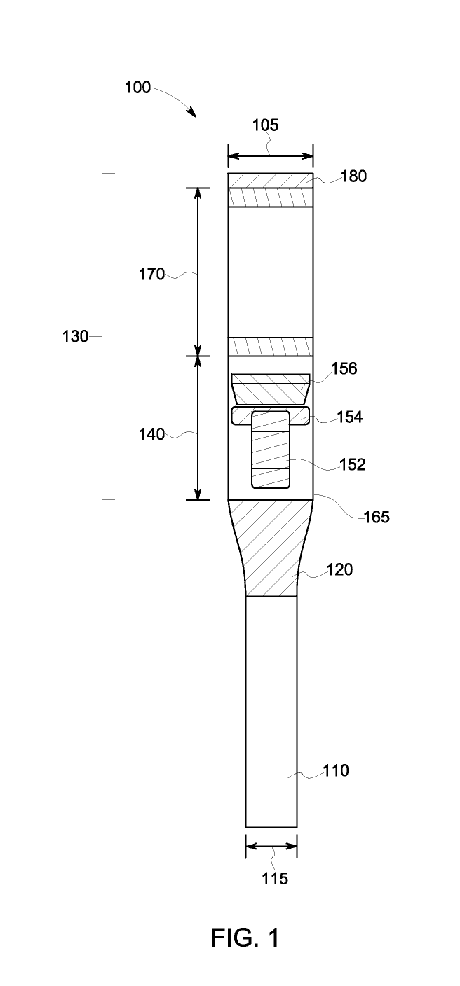

FIG. 1 is front view of a luminaire assembly 100, which can be configured into various arrangements for different applications. The luminaire assembly 100 includes a support 110, an adapter 120, and a luminaire fixture 130.

The support 110 serves as the structure that secures the fixture 130 in a specified location. The support 110 may be anchored to the ground or other object (e.g., concrete pedestal) to create a foundation for the fixture 130. Alternately, the support 110 may be anchored to an over-head structure (e.g., a ceiling).

The support 110 may include (1) a void or opening (not shown) to contain wiring within the support 110 or (2) one or more mounts (not shown) to secure wiring to a perimeter 115 of the support 110. The support perimeter 115 may be configured to define a geometric shape including but not limited to a circle, a rectangle, or a square.

In some embodiments, the support 110 may be a light pole, having a diameter, is a means by which the fixture 130 is raised above the ground. Typical light pole diameters may range from 50 millimeters (mm) to more than 200 mm.

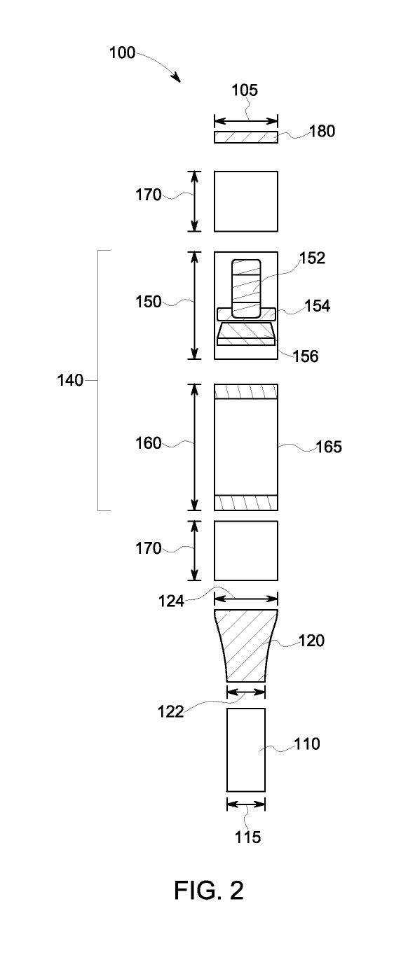

The adapter 120 connects the fixture 130 to the support 110. To do so, the adapter 120 may have a beginning perimeter 122 (seen in FIG. 2) configured to engage the support perimeter 115. More specifically, the support perimeter 115 may be received by the beginning perimeter 122, or vice versa. Additionally, to accommodate a size and/or shape difference between the support 110 and the fixture 130, the adapter 120, has an ending perimeter 124 (seen in FIG. 2) configured to engage a base of the fixture 130, the base having a fixture perimeter 105. Specifically, the ending perimeter 124 may be received by the fixture perimeter 105 at the base of the fixture 130, or vice versa.

A transition from the beginning perimeter 122 to the ending perimeter 124 may be gradual or funnel-like transition, as depicted in FIG. 2. Additionally, the adapter 120 may contain a plurality of sections configured to connect to one another in a succession that facilitates the transition.

The fixture 130, having the perimeter 105, provides illumination for specific lighting applications. The fixture 130 includes a lighting assembly 140 and a configurable component 170. To facilitate assembly and allow for multiple arrangements, the lighting assembly 140 and the configurable component 170 may each have a perimeter configured to engage one another. Specifically, the lighting assembly 140 may be received by the configurable component 170, or vice versa.

The lighting assembly 140 is the source of the light emission from the fixture 130. The lighting assembly 140 may include light emitting components (e.g., light emitting diodes (LEDs)) and/or optical components (e.g., lenses). Additional properties and components of the lighting assembly 140 are described in detail below.

In addition to illumination due to the lighting assembly 140, the configurable component 170 incorporates functionality into the fixture 130. Functionality added by the configurable component 170 may include data receipt to and/or transmission from a system internal or external to the fixture 130.

Additionally, the configurable component 170 allows multiple arrangements of the fixture 130. For example, the lighting assembly 140 may be located near the adapter 120 at the base of the fixture 130 (as seen in FIG. 1). Alternately, the configurable component 170 may be located near the adapter 120, at the base of the fixture 130 (as seen in FIG. 2).

In some embodiments, the fixture 130 includes a plurality of configurable components 170 (seen in FIG. 2). At least one of the configurable components 170 may be in connection with the lighting assembly 140. However, additional configurable components 170 may be in connection with other configurable components 170 and/or the lighting assembly 140.

Additional properties and components of the configurable component(s) 170 are described in detail below.

In some embodiments, the fixture 130 may also contain a cap 180, which serves to shield the top of the fixture 130 from environmental elements (e.g., rain, dust, debris). The cap 180 may serve to protect the internal components of the fixture 130 (e.g., lighting assembly 140 and/or configurable component 170). To protect the fixture 130, the cap 180 may be configured to engage a top of the fixture 130, the top having the fixture perimeter 105. Specifically, the cap 180 may be received by the fixture perimeter 105 at the top of the fixture 130, or vice versa.

FIG. 2 is an exploded view of the luminaire assembly 100, which is a depiction illustrating the lighting assembly 140 and the configurable component 170. As seen in FIG. 2, the lighting assembly 140 may include a light emitter 150 and/or an optical zone 160.

The light emitter 150 may include a driver 152, to facilitate programing of the fixture 130, and a module 154, to produce the illumination from a light source.

The driver 152 may be programmable logic used to set conditional events on which the light emitter 150 functions. Programming may alter aspects of the driver 152 including, but not limited to light intensity, light wavelength, and light direction.

The driver 152 may be controlled by means of a logic device, including but not limited to, a microcontroller, microprocessor, programmable logic controller (PLC), complex programmable logic device (CPLD), and/or field-programmable gate array (FPGA). The controller may use code libraries, static analysis tools, software, hardware, firmware, or the like. Any use of hardware or firmware includes a degree of flexibility and high-performance available from an FPGA, combining the benefits of single-purpose and general-purpose systems.

Additional input/output systems (I/O systems) may also be used to receive information from and provide information to the driver 152. These I/O systems and firmware may include but are not limited to relay drive outputs per relay, indicator outputs, and logic outputs. After reading this description, it will become apparent to a person skilled in the relevant art how to implement the technology using other assemblies.

The module 154 contains a lighting element (not shown) such as an LED or the like. The lighting element, receives energy from the power source and produces the illumination.

The illumination is then configured by the optical zone 160 into a desired luminous flux, for the lighting application. The optical zone 160 includes an optics element 156 and the cover 165, which work together to refract, bend, or otherwise modify light to provide a luminous flux suitable for the lighting application.

The optics element 156 may be positioned in a direction that facilitates emission of the desired luminous flux. The optics element 156 may include one or more traditional optical devices such as lenses, reflectors, mirrors, and the like. The optics element 156 may also include optical enhancement characteristics, such as, but not limited to coatings and apertures.

The cover 165 is a protective screen that covers the optical zone 160. The cover 165 may also function to alter optical effects (e.g., reducing light intensity) of the light emitter 150 through use of color and texture, among others.

In some embodiments, the cover 165 is configured to interchange for different lighting applications. For example, the cover 165 may be of a clear thermoplastic material (e.g., polycarbonate) for applications where the fixture 130 is near the ground, where the desired luminous flux intensity may be high because the light is not in direct contact with human eyes. However, the cover 165 may be of an opaque thermoplastic material for applications where the fixture 130 is above ground, where the desired luminous flux may be lower because the light is in direct contact with human eyes.

As stated above, the configurable component 170 incorporates additional functionality within the fixture 130.

In some embodiments, the configurable component 170 includes components that measure and/or record conditions surrounding the fixture 130. For example, one or more motion sensors may be included within the configurable component 170 to detect animate objects within a specified lighting area. As another example, the configurable component 170 may include one or more photocell panels to detect the amount of daylight received into the specified lighting area.

In some embodiments, the configurable component 170 includes components configured to allow data transmission and/or receipt between the configurable component 170 and an external system. For example, the configurable component 170 may be in communication with a mobile device (e.g., mobile phone) though a communication unit (not shown).

In some embodiments, the communication unit may include an element to allow the configurable component 170 to serve as an internet connection or otherwise allow devices within the specified lighting area to transmit and/or receive information, similar to a mobile “hotspot”. Thus, when the fixture 130 includes the communication unit to allow data interaction, a mobile device may have wireless communication with other devices within the specified lighting area.

In some embodiments, the communication unit may be configured to transmit data to store and/or analyze at a location internal and/or external to the fixture 130. Such data may be transmitted and/or stored on a server, a virtual storage (e.g., cloud), or the like. Transmitted data may include information such as, but not limited to, environmental conditions (e.g., weather or atmospheric data) perceived by the fixture 130. Transmitted data may be used to evaluate the lighting application and alter, if needed, characteristics of the fixture 130 such as, but not limited to, fixture positioning or the luminous flux provided by the fixture 130.

After reading this description, it will become apparent to a person skilled in the relevant art how to implement the technology using other computer systems and/or computer architectures for the configurable component 170.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What we claim is:

1. A multifunctional luminaire fixture comprising:
a base, having a base perimeter, in connection with a fixture support, having a fixture support perimeter;
a lighting component, having a first component perimeter, including a (i) light emitter, to facilitate light emission, and (ii) an optical zone, to regulate luminous flux, wherein the light emitter is in connection with the optical zone;
at least one configurable component, having a second component perimeter, in communication with at least one portion of a system external to the lighting component; and
a top, having a top perimeter, wherein the top is positioned opposite the fixture support, the top having a top perimeter.

2. The fixture of claim 1, further comprising an adapter having a beginning perimeter configured to receive the fixture support perimeter and an ending perimeter configured to receive the base perimeter.

3. The fixture of claim 2, wherein the beginning perimeter encloses a first area and the ending perimeter encloses a second area, wherein the first area is generally dissimilar from the second area.

4. The fixture of claim 1, further comprising a cover, affixed to at least a portion of the first component perimeter, configured to alter luminous flux intensity of the light emitter.

5. The fixture of claim 1, wherein the at least one portion of the system external to the lighting component is configured to facilitate data transmission.

6. The fixture of claim 1, further comprising a cap, having a cap perimeter, configured to receive the top perimeter.

7. A multifunctional luminaire fixture comprising:
a base, having a base perimeter, in connection with fixture support, having a fixture support perimeter;
a lighting component, having a first component perimeter, including a (i) light emitter, to facilitate light emission, and (ii) an optical zone, to regulate luminous flux, wherein the light emitter is in connection with the optical zone;
a plurality of configurable components, each having a perimeter, in communication with at least one portion of a system external to the lighting component; and
a top, having a top perimeter, wherein the top is positioned opposite the fixture support, the top having a top perimeter.

8. The fixture of claim 7, further comprising an adapter having a beginning perimeter configured to receive the fixture support perimeter and an ending perimeter configured to receive the base perimeter.

9. The fixture of claim 8, wherein the beginning perimeter encloses a first area and the ending perimeter encloses a second area, wherein the first area is generally dissimilar from the second area.

10. The fixture of claim 7, further comprising a cover, affixed to at least a portion of the first component perimeter, configured to alter luminous flux intensity of the light emitter.

11. The fixture of claim 7, wherein the lighting component is in communication with at least one of the plurality of configurable components.

12. The fixture of claim 7, wherein at least one of the plurality of configurable components is in connection with another of the plurality of configurable components.

13. The fixture of claim 7, wherein the at least one portion of the system external to the lighting component is configured to facilitate data transmission.

14. The fixture of claim 7, further comprising a cap, having a cap perimeter, configured to receive the top perimeter.

15. A method for configuring a multifunction luminaire fixture, comprising:
connecting, a lighting component, including a light emitter in connection with an optical zone, to at least one configurable component; and
connecting, the lighting component, to a fixture support, having a fixture support perimeter.

16. The method of claim 15, further comprising connecting, an adapter, having a beginning perimeter configured to receive the fixture support perimeter and an ending perimeter configured to receive a fixture base, having a base perimeter, to the fixture support.

17. The method of claim 15, wherein the beginning perimeter encloses a first area and the ending perimeter encloses a second area, wherein the first area is generally dissimilar from the second area.

18. The method of claim 15, further comprising connecting, to the lighting component, a plurality of configurable components.

19. The method of claim 18, wherein at least one of the plurality of configurable components is in connection with the lighting component at a location (i) on a first side the lighting component and (i) on a second, opposite side of the lighting component.

20. The method of claim 18, wherein at least one of the plurality of configurable components is in connection with another of the plurality of configurable components.
